(19) United States
(12) Patent Application Publication
(10) Pub. No.: US 2015/0212201 A1
(43) Pub. Date: Jul. 30, 2015

(54) LOW-ENERGY LASER SEEKER

(71) Applicant: ISRAEL AEROSPACE INDUSTRIES LTD., Lod (IL)

(72) Inventors: Uri Karazi, Nof Ayalon (IL); Benjamin Levy, Yehud (IL); Valery Heymann, Yehud (IL)

(21) Appl. No.: 14/412,976

(22) PCT Filed: Jul. 4, 2013
(86) PCT No.: PCT/IL2013/050571

§ 371 Date: Jan. 5, 2015

(30) Foreign Application Priority Data
Jul. 4, 2012 (IL) 220758

(51) Int. Cl. G01S 7/486; G01S 17/66

(52) U.S. Cl. CPC G01S 7/4861; G01S 17/66

(57) ABSTRACT

The presently disclosed subject matter includes a method and system for enabling detection of signal reflection from a target designated by a pulse laser spot generated by a low-power laser designator. A signal comprising true signal portions reflected from said target and noise is received and sampled and a first value or a second value is assigned to each sample. The assigned (i^{th}) values in K pulse rate intervals are summed to obtain respective summed values. One or more candidate clusters are identified from among the summed values and a final candidate cluster is selected from among said one or more candidate clusters. The final candidate cluster is located with respective samples of an incoming pulse rate interval, thereby detecting an area within said signal which comprises the true signal portions.

### FIELD OF THE INVENTION

This invention relates to the field of guiding a platform to a target with the help of a laser signal.

### BACKGROUND OF THE INVENTION

Designating targets using laser spots is a widely known technique due to the high precision of the pointing laser device and the relatively low cost of the homing head (or seeker). For example the seeker can be mounted on an intercepting platform, such as a missile, and utilize the energy reflected from an illuminated target, for generating steering commands and homing the intercepting platform towards a target (such as a moving vehicle).

As illustrated schematically in FIG. 1, according to known laser spot guiding techniques, a laser designator 1 constantly tracks the target 3 and illuminates it with a pulsed spot laser beam 4. FIG. 1 also illustrates an intercepting platform 5 (in this case a missile) employing a seeker with a laser sensor. The sensor's surface is often divided into four equal sectors (not shown in FIG. 1) and associated with a spectral filter which transfers energy reflected from the illuminated target as well as a certain portion of noise (that stems, e.g. from sunlight). The energy received in each of the sectors of the sensor is converted into corresponding signal intensity. The differences between the signal intensities in the respective sectors are used to calculate the direction to the target (line of sight—LOS 6) and/or the change of direction LOS rate. The calculated LOS and/or LOS rate serve for steering the missile for homing onto the target 3.

Published references considered to be relevant as background to the presently disclosed subject matter are listed below. Acknowledgement of the references herein is not to be inferred as meaning that these are in any way relevant to the patentability of the presently disclosed subject matter.

U.S. Pat. No. 6,043,867 discloses an interceptor fitted with a target tracker unit that includes a passive infrared tracker capable of sensing infrared radiation (IR) emitted from a flying target and being responsive to the sensed IR radiation, for generating a succession of Line of Sight (LOS) and/or LOS rates signals that are stored in a database. Self state means capable of providing a succession of interceptor's self state data. An electro-magnetic range finder includes a transmitter assembly for transmitting pulsed radiations and receiver assembly for receiving reflections that surpasses adjustable detection threshold. The electro-magnetic finder is configured to operate at first detection threshold for receiving reflections of relatively low magnitude, and storing the reflections in the database. A target reflection detection module communicating with the database, for detecting target reflections from among those stored in the reflection database. An estimator includes a range-based target estimator for calculating target state estimations on the basis of detected target reflections, the LOS measurements and self stage data, thereby facilitating early steering of the interceptor for duly homing said interceptor onto the target.

U.S. Pat. No. 8,054,451 discloses a system that includes a laser designator configured to continuously designate a target with a pulsed laser spot. The system includes a sensor and associated processing system configured to receive a reflection of the laser spot, convert the received energy to a plurality of signals, processing the signals for detecting true reflected signals and processing the true reflected signals for generating target related action. The sensor and associated processor are configured to detect the true signals notwithstanding an inherent low Signal/Noise ratio of below 4 of the received signals from due to low pulse power of the laser designator and distance to target.

General Description

According to one aspect of the presently disclosed subject matter there is provided a method of detecting a signal reflected from a target designated by a pulse laser spot, the method comprising: receiving a signal comprising true signal portions reflected from the target, and noise; sampling a plurality (M) of samples of a plurality of pulse repetition intervals in the signal; assigning either a first value or a second value based on a predefined criterion, for each sample of the plurality of samples or a combination thereof; performing summation of respective assigned (i^{th}) values in K pulse rate intervals, and obtaining respective summed values; identifying one or more candidate clusters from among the summed values; selecting a final candidate cluster from among the one or more candidate clusters; the final candidate cluster representing a range of indexes within the summation vector that corresponds to true signal portions from among the plurality of samples; locating the final candidate cluster with respective samples of an incoming pulse rate interval, thereby detecting a restricted area within the signal which comprises the true signal portions.

According to certain embodiments the method further comprising: prior to performing the summation, inserting the assigned value to a respective cell i in a row of a matrix comprising K rows, each row comprising the values of a respective PRI; and performing the summation as a summation of a respective cell i in K rows thereby generating a summation vector.

According to certain embodiments wherein the signal is received by a 4 quarters laser sensor, each quarter associated with a respective processing channel, wherein the sampling and assigning is performed for each of the 4 quarters, the method further comprising: performing a logical OR on each respective (i^{th}) value in each of the 4 processing channels, thereby obtaining a consolidated value from all 4 processing channels and performing the summation with the consolidated value.

According to certain embodiment wherein the signal is received by a 4 quarters laser sensor, each quarter associated with a respective processing channel, wherein the sampling and assigning is performed for each of the 4 quarters, the method further comprising: summing values of respective samples received in at least each pair of adjacent quarters, thereby generating 4 intermediate processing channels; performing the assigning on the 4 intermediate processing channels; and performing a logical OR operation on each respective (i^{th}) value in each of the 4 processing channels and the 4 intermediate processing channels, thereby obtaining a consolidated value from all 8 processing channels.

According to certain embodiments the method further comprising: adding a plurality of samples on each side of the area thereby generating a tracking window; and identifying a final true sample within the tracking window, the final true sample representing energy of the laser spot reflected from the target.

According to another aspect of the presently disclosed subject matter there is provided a laser seeker operable for detecting a signal reflected from a target designated by a pulse laser spot, the seeker comprising: a sensor associated with at least one processing channel; the processing channel comprising a sampler, an accurate clock and a processing unit; the sensor is operable to receive a signal comprising true signal portions reflected from the target, and noise; the sampler and associated accurate clock, are operable to sample a plurality of samples of a plurality of pulse repetition intervals of the received signal; the processing unit is operable to perform at least the following operations: assign either a first value or a second value based on a predefined criterion, for each sample of the plurality of samples or a combination thereof; sum respective assigned (i^{th}) values in K pulse rate intervals, and obtain respective summed values; identify one or more candidate clusters from among the summed values; select a final candidate cluster from among the one or more candidate clusters; the final candidate cluster representing a range of indexes within the summation vector that corresponds to true signal portions from among the plurality of samples; locate the final candidate cluster with respective samples of an incoming pulse rate interval, thereby detecting a restricted area within the signal which comprises the true signal portions.

According to certain embodiments the processing unit in the laser seeker is further operable, prior to performing the summation, to insert the assigned value to a respective cell i in a row of a matrix comprising K rows, each row comprising the values of a respective PRI; and perform the summation as a summation of a respective cell i in K rows thereby generating a summation vector.

According to certain embodiments wherein the sensor is a 4 quarters laser sensor, each quarter associated with a respective processing channel, each processing channel comprising a sampler operable to sample a signal received by a respective quarter, the assigning is performed for each of the 4 processing channels, the processing unit is further operable to perform a logical OR on each respective (i^{th}) value in each of the 4 processing channels, thereby obtaining a consolidated value from all 4 processing channels and sum the consolidated values.

According to certain embodiments K is between 2 to 20.

According to certain embodiment the pulse laser spot is characterized by a rate of between 10 to 25 pulses per second and a power between 10 to 45 millijoules.

According to certain embodiments the sampling is configured to operate at a sampling rate between 50 to 200 Mega Hertz.

According to certain embodiments a clock associated with a laser designator, designating the pulse laser spot is not synchronized with the accurate clock in the seeker.

According to certain embodiments the laser seeker integrated in a laser system, the laser system further comprising a laser designator operable for designating the pulsed laser spot.

According to another aspect of the present invention there is provided a program storage device readable by machine, tangibly embodying a program of instructions executable by the machine to perform method steps of detecting a signal reflected from a target designated by a pulse laser spot, the method comprising: receiving information indicative of a plurality of samples of each pulse rate interval in a signal reflected from a target designated by a pulse laser spot, the signal comprising true signal portions reflected from the target, and noise; assigning either a first value or a second value based on a predefined criterion, for each sample of the plurality of samples or a combination thereof; performing summation of respective assigned (i^{th}) values in K pulse rate intervals, thereby obtaining respective summed values; identifying one or more candidate clusters for among the summed values; selecting a final candidate cluster from among the one or more candidate clusters; the final candidate cluster representing a range of indexes within the summation vector that corresponds to true signal portions from among the plurality of samples; aligning the final candidate cluster with respective samples of an incoming pulse rate interval, thereby detecting a restricted area within the signal which comprises the true signal portions.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic illustration showing a typical scenario of intercepting a vehicle using laser pointing technique;

FIG. 2 is a functional block diagram schematically illustrating a laser seeker unit, in accordance with the presently discloses subject matter;

FIG. 3 is flowchart showing operations which are carried out during target detection process, in accordance with the presently disclosed subject matter;

FIG. 4 is a functional block diagram schematically illustrating a sensor and associated processing unit, in accordance with the presently disclosed subject matter;

FIG. 5 is flowchart showing operations which are carried out during target detection process, in accordance with the presently disclosed subject matter;

FIG. 6a shows an example, in small scale, of a binary matrix, in accordance with the presently disclosed subject matter;

FIG. 6b shows a summation vector, in accordance with the presently disclosed subject matter;

FIG. 6c shows non-limiting examples of possible filters which can be used in accordance with the presently disclosed subject matter;

FIG. 7 is a flowchart illustrating an example of operations carried out during a filtering process, in accordance with the presently disclosed subject matter;

FIG. 8 is a flowchart showing operations which are carried out during a target tracking process, in accordance with the presently disclosed subject matter; and

FIG. 9 is a flowchart illustrating the operation performed in a guard process, in accordance with the presently disclosed subject matter.

### DETAILED DESCRIPTION OF EMBODIMENTS

In the drawings and descriptions set forth, identical reference numerals indicate those components that are common to different embodiments or configurations. Unless specifically stated otherwise, as apparent from the following discussions, it is appreciated that throughout the specification discussions utilizing terms such as “receiving”, “performing”, “identifying”, “selecting”, “locating”, “inserting”, “adding”, “summing” or the like, include action and/or processes of a computer that manipulate and/or transform data into other data, said data represented as physical quantities, e.g. such as electronic quantities, and/or said data representing the physical objects.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

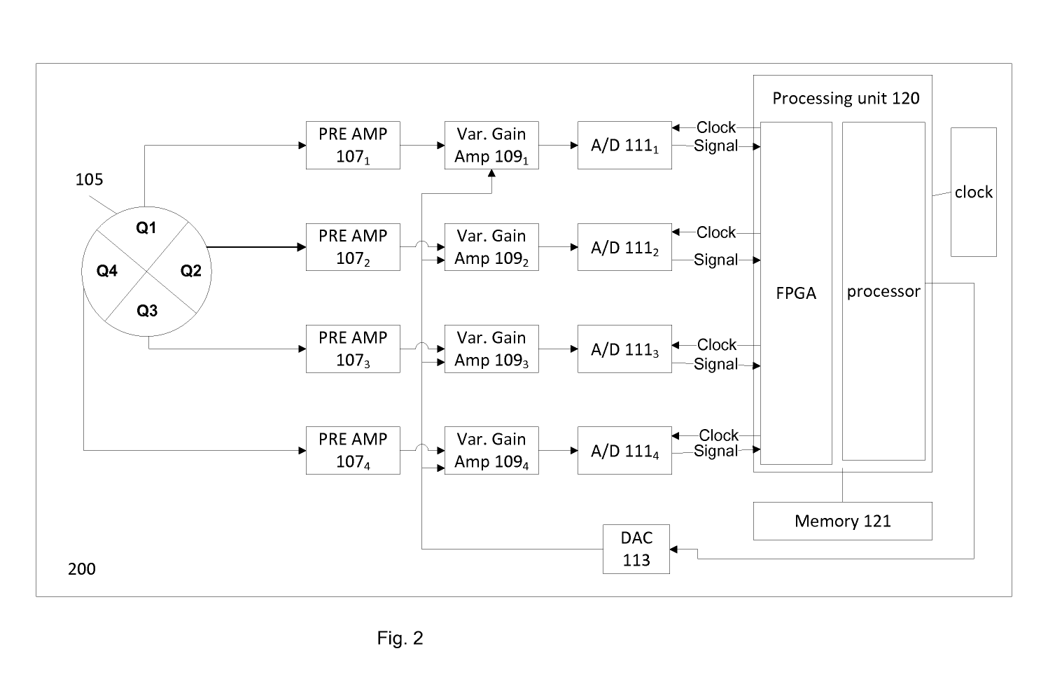

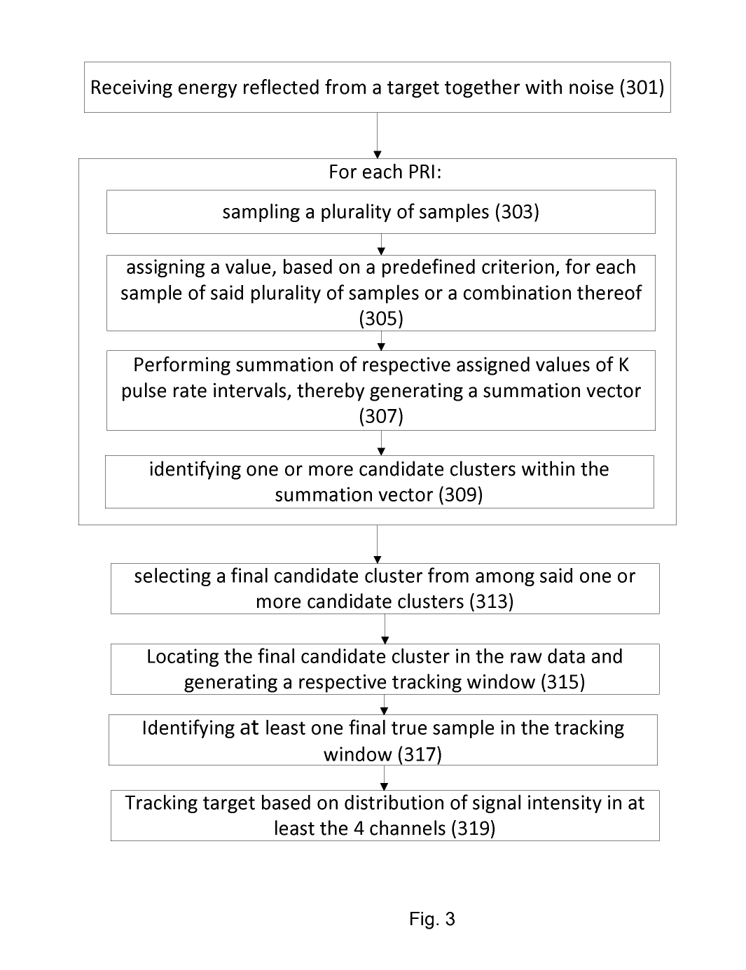

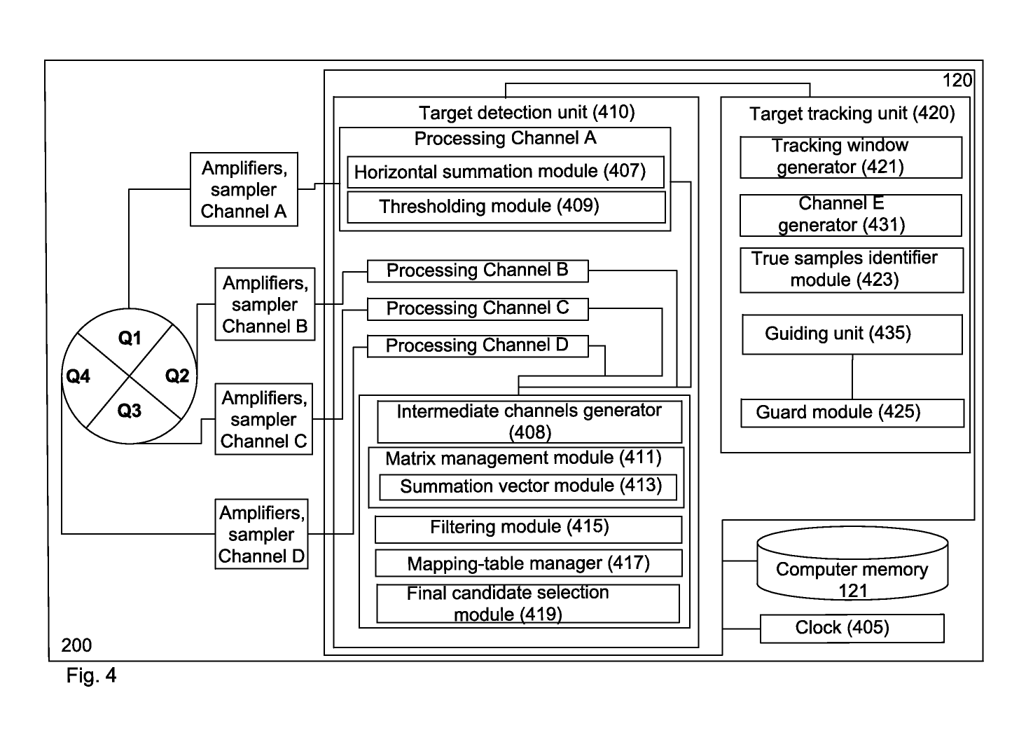

In embodiments of the presently disclosed subject matter, fewer, more and/or different stages than those shown in FIGS. 3, 5, 7, 8 and 9 may be executed. In embodiments of the presently disclosed subject matter one or more stages illustrated in FIGS. 3, 5, 7, 8 and 9 may be executed in a different order and/or one or more groups of stages may be executed simultaneously. FIGS. 2 and 4 illustrate schematics of the system architecture in accordance with an embodiment of the presently disclosed subject matter. The elements in FIGS. 2 and 4 may be centralized in one location or dispersed over more than one location. In different examples of the presently disclosed subject matter, the system may comprise fewer, more, and/or different elements than those shown in FIGS. 2 and 4. The invention is not bound by the specific architecture depicted in FIGS. 2 and 4; equivalent and/or modified functionality may be consolidated or divided in another manner and may be implemented in any appropriate combination of software, firmware and hardware.

As described below the laser seeker disclosed herein comprises or is otherwise associated with at least one processor operable for executing related operations as described herein. The term “processor” should be expansively construed to cover any kind of electronic device with data processing capabilities, including, by way of non-limiting example, a computing system, a digital signal processor (DSP), a microcontroller, a field programmable gate array (FPGA), an application specific integrated circuit (ASIC), etc.) or any other appropriate electronic computing device, and or any combination thereof.

Further, it should be noted that the term “criterion” as used herein should be expansively construed to include any compound criterion, including, for example, several criteria and/or their logical combinations.

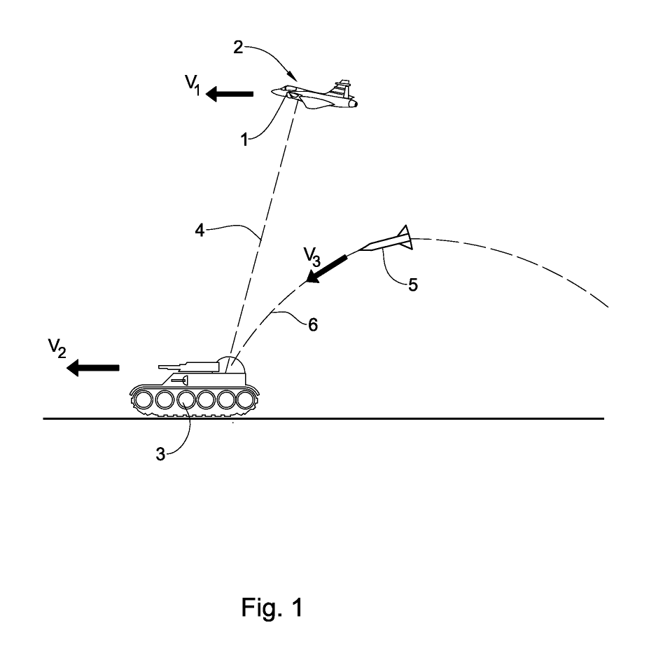

Bearing the above in mind, the description now returns to FIG. 1. In accordance with one (yet not exclusive) scenario, laser designator 1 transmits pulses at a rate of 10-20 Hz, facilitating sampling of energy reflected from a designated target for homing purposes. The wavelength that is used can be for example 1064 nanometers. Each pulse is narrow (15-20 nanoseconds) and has generally energy of 80 to 120 millijoules. Energy between 80 to 120 millijoules is used in order to secure sufficient signal to noise ratio that will be received in the sensor and will allow discerning between true signals, reflected from the target, and ambient noise (such as sunlight) at a sufficient level of certainty. The energy received by the sensor is converted to electrical current/voltage, depending also on the sensor's sensitivity. This output power of the laser allows the intercepting missile to process the so discerned signal at sufficient range from the target, providing a signal to noise ratio (typically between 6 to 10), which is sufficient for example, for generating steering commands for the intercepting missile in order to achieve an accurate homing onto the target 3.

Techniques directed for processing the reflected energy of a laser beam for homing a platform towards its target suffer from a number of disadvantages. For example, those existing techniques which depend on a high energy laser beam require laser designators generating a reflected beam with energy around 80 to 120 millijoules, which are characterized by a relatively high price tag. In addition, such laser designators are also characterized by a relatively large physical dimensions as well as relatively high weight which hinder the possibility to carry portable laser designators by a person such as an infantry individual, or fitting them in a vehicle (for instance Unmanned Ground/Arial Vehicle).

A possible solution to the above deficiencies is to use low-energy laser designators which are characterized by lower-weight and smaller dimensions as well as lower costs. Among laser designators which are available today, are low-energy laser designators operating with energy of around 10 to 45 millijoules. Such laser designators can also provide a pulse rate of 10 to 25 Hz (also referred to as “pulse per second” (PPS)), at a time of 15 to 20 nanoseconds, similar to the high-energy designator described above. Such laser designators can be carried by a platform that is limited by its capacity to carry heavy payload, for example an infantry soldier or a low weight flying platform (e.g. UAV).

However, due to the low power of the laser beam, and further due to the fact that in typical laser guiding scenarios, at the initial intercepting phase the intercepting platform is relatively far away from the designated target, the energy which is reflected from the designated target and received by the sensor is inherently of low intensity. As the signal to noise ratio is naturally low, this may create numerous false alarms, each seemingly indicating the existence of a signal value, whereas in reality it is a noise having energy level which is very close to that of the low signal value. The reflected energy may, therefore, be insufficient for enabling known in the art seekers to properly discern between signal and noise in order to calculate the angular error and angular error rate, and thus cannot be used for accurately homing a platform to its designated target.

U.S. Pat. No. 8,054,451 discloses a technique for processing reflected energy which is directed for working with a low power laser beam. However, this technique relies on laser designators working at high pulse frequency, at the order of 5000 Hz, and is therefore not suitable to operate with laser designator with a lower pulse frequency such as for example 10 to 25 Hz.

Accordingly, the presently disclosed subject matter includes, inter alia, a laser seeker which is operable to receive reflected energy of a laser beam generated by a low-power laser designator, to generate electric signals from the received energy and utilize the electrical signals for guiding a platform to its designated target. The presently disclosed subject matter offers a solution which enables to discern between true laser signals (i.e. reflected from a target) and noise, even when the signal to noise ratio is low (e.g. lower than 3). Accordingly, among one of its advantages, the presently disclosed subject matter enables to use a low power laser designator operating at around 10 to 25 millijoules and achieve similar performance at similar ranges and conditions of an 80 to 120 millijoules laser designator.

Turning to FIG. 2, this shows a functional block diagram schematically illustrating a laser seeker unit, in accordance with the presently disclosed subject matter. Laser seeker 200 comprises a sensor head 105 that is divided into four sectors (quarters), denoted by Q1, Q2, Q3 and Q4, each sector being associated with an individual processing channel. Sensor head 105 is configured to receive incoming reflection of light, including reflected laser signal and noise. The received energy, in each channel, is transmitted first to a respective pre-amplifier 107₍₁₋₄₎ and then to a respective variable gain amplifier 109₍₁₋₄₎. Pre-amplifier 107₍₁₋₄₎ and variable gain amplifier 109₍₁₋₄₎ are operable to amplify or attenuate the intensity of the received signals in order to maintain the intensity of the signal within a required range. Processor 120 is connected via DAC 113 to each variable gain amplifier 109₍₁₋₄₎, in a feedback loop, in order to facilitate automatic gain control (ACG) of the received signal. The analog incoming signals in each of the 4 channels are transmitted to a respective A/D sampler 111₍₁₋₄₎, which is associated with a clock and configured to sample the signals at a predefined rate (e.g. 10 bit A/D sampler). The digital signal samples are then forwarded to processing unit 120 which is configured, inter alia, to run a target detection process and a target tracking process as explained below in more detail. Processing unit 120 can include for example field-programmable gate array (FPGA) components, a clock generator and can be associated with computer memory 121.

FIG. 3 is a general flowchart illustrating operations which are carried out during target detection and tracking processes, in accordance with the presently disclosed subject matter. At block 301, energy reflected from a target along with ambient noise is received at sensor head 105. Each of the four quarters of the sensor head receives a certain amount of energy.

At block 303, for each pulse repetition intervals (PRI) of the incoming signal in each quarter, a plurality of samples are sampled by a sampler 111 of a respective processing channel. The PRI is the time interval elapsing from one pulse to the next. The sampled values are forwarded to processing unit 120, where the true signal detection process and target tracking process is executed.

As described in more detail below, each sample (or a combination thereof) is assigned with a value, based on a predefined criterion related to the intensity of the sample (block 305). For example, two values can be used where each sample (or a combination thereof) is assigned with a first value or a second value, based on a predefined criterion related to the intensity of the sample. A value is assigned to each i^{th} sample (or a combination of samples) in a PRI received by each of the 4 quarters, thereby obtaining at least 4 assigned values for each pulse.

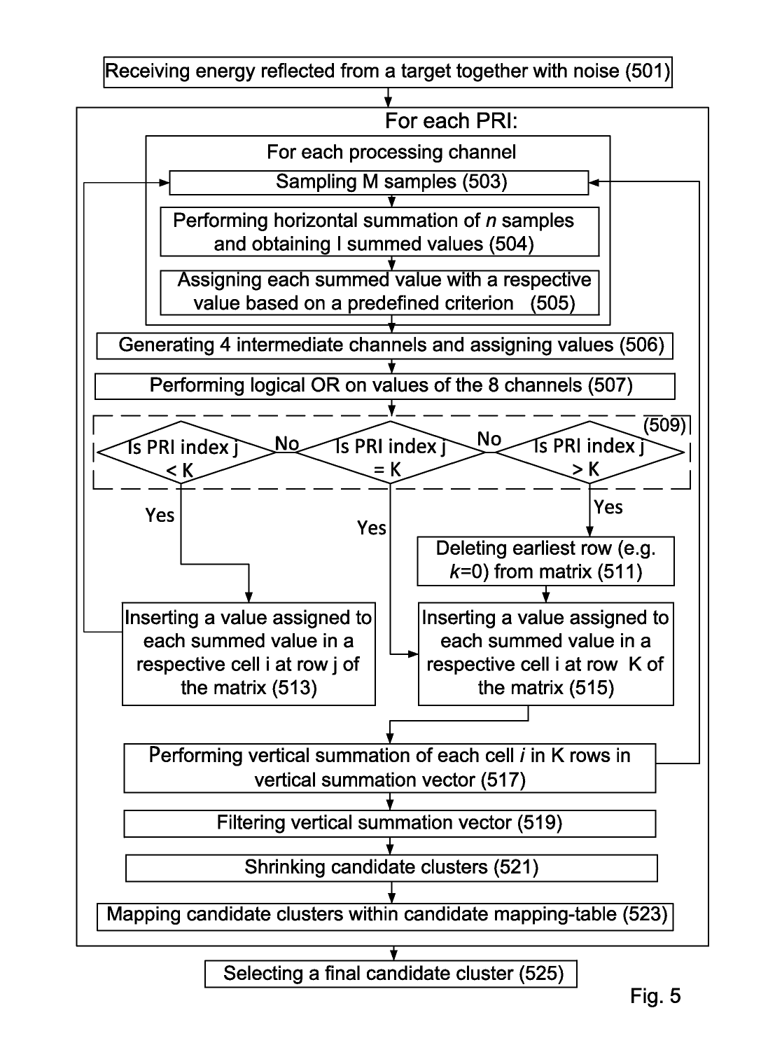

By way of example only and as explained in more detail below with reference to FIG. 5, a matrix can be facilitated for the purpose of performing the detection process disclosed herein. For example, each of the values assigned to each sample (or combination of one or more samples) in a given PRI, can be inserted to a respective cell i in a row of a matrix. A logical OR operation can be performed on the values assigned to the samples received at each one of the 4 quarters. In case there is at least one value which is indicative of an intensity of a sample (or combination of one or more samples) above the threshold, this value is inserted in the respective cell in the matrix. This way a pulse which is received in (at least) 4 channels is consolidated in a single cell of the matrix.

The matrix can comprise K rows, each row comprising the values assigned to respective samples (or combination of samples) of one PRI. It should be noted however, that the use of a matrix for this purpose, as well as the matrix type and its specific characteristics, are described merely as an example and should not be construed as limiting. For example, instead of a matrix, each value which is assigned to a respective sample (or combination thereof) can be identified by a corresponding index number or time stamp.

At block 307 the respective (i^{th}) assigned values in K pulse repetition intervals are summed, thereby generating a summation vector. For example, in case a matrix is facilitated for storing the assigned values in its respective matrix cells, summation of a respective cell i in K rows can be performed, thereby generating a summation vector.

As explained in more detail below, for each summation vector a filtering process is carried out in order to identify one or more candidate clusters within the summation vector (bock 309). Candidate clusters represent areas within the summation vector which are potentially indicative of samples within a PRI that represent true signal portions reflected from the target.

Once the samples of a predefined (K) number of PRIs have been processed and respective one or more candidate clusters have been identified, a final candidate cluster is selected from among the candidate clusters (block 313). The final candidate cluster is expected to represent a range of indexes within the summation vector that includes true signal portions of a laser signal reflected from an illuminated target.

The final candidate cluster is located (e.g. aligned) within an incoming PRI in order to locate a region within the PRI which comprises true signal portions (samples) and generate a respective tracking window (block 315). The tracking window defines a restricted area within the signal in which reflection of true laser signal is expected to be found and enables to focus the detection process to this area.

At block 317 at least on final true sample is identified within the tracking window. The final true samples are a group of consecutive samples of the laser signal which were generated by energy reflected from the illuminated target. From among the final true samples a final true sample is identified.

Once the location of at least one final true sample within the PRI is identified, the intercepting platform can be guided towards the target based on distribution of signal intensity in at least the 4 channels (block 319). A more detailed description of operations performed during the detection and tracking process is described below.

FIG. 4 is a functional block diagram schematically illustrating a sensor and associated processing unit, in accordance with the presently disclosed subject matter. For better clarity, in the following description, the operations in FIGS. 5, 7, 8 and 9 are described with reference to the elements illustrated in FIG. 4. However, it should be understood that the specific functional elements which are illustrated in FIG. 4 are merely non-limiting examples and more, less or different elements can be used instead or in addition to these elements. Furthermore, it should be appreciated to those versed in the art that some of the specific technical characteristics of the laser designator and seeker which are described herein represent merely non-limiting examples and variations of these characteristics reside within the scope of the teaching disclosed herein.

As mentioned above, a seeker 200 is fitted on an intercepting platform (e.g. missile 5) and includes a sensor head 105 that is divided into four sectors (quarters), designated Q1 to Q4, respectively. Each sector is associated with a distinct processing channel constituting a part of a processing system. For simplicity, only processing channel A associated with sector Q1 is elaborated. The other sectors Q2 to Q4, are associated with processing channels B to D, which are substantially identical processing channels to channel A. All 4 processing channels operate substantially at the same time.

Seeker 200 further comprises processing unit 120 which is associated with one or more processors and a computer memory 121. Processing unit 120 can comprise a target detection unit 410 operable to process incoming signal samples and identify samples representing true signal portions of laser energy reflected from a target. Processing unit 120 can further comprise a target tracking unit 420 operable to track a target which has been detected by target detection unit 410 and facilitate guidance of the intercepting platform towards the target. A more detailed description of the operation of the different components of processing unit 120 is provided below.

In general, after having determined the location of true signal portions within the PRI, the intensity of the signal in the so determined location in at least each of the four channels is compared in order to calculate the error between the true LOS to the target and the direction of the seeker, and derive therefrom LOS direction and/or LOS direction rates to the target, which facilitate appropriate guidance of the intercepting platform to the target. LOS direction and/or LOS direction rates are examples of LOS related data.

Note, that unlike other types of sensors, which in order to compensate for a low signal to noise ratio are divided into small compartments (i.e. sensors matrix) each with a limited reception angle, each of the four quarters in a four quarters sensor provides a wide angle of detection and accordingly the wide angle of detection is more susceptible to receiving noise in addition to true signals.

Turning to FIG. 5, it shows a flowchart of operations which are carried out during the target detection process, in accordance with the presently disclosed subject matter. FIG. 5 illustrates an example in which binary values are assigned and inserted horizontally into rows of a binary matrix. As asserted above, this is merely a non-limiting example and other variations of this approach reside within the scope of the presently disclosed subject matter. Such variations include for example, other data structures which can be used instead of a matrix. In addition, other non-binary values can be used instead of binary values, and also the assigned values can be inserted vertically, instead of horizontally, into a corresponding table.

At block 501 The energy reflected from the target (in response to the illuminating spot of the designator pulse) is received by the sensor together with energy which originated from ambient noise (such as sunlight) and is converted to a signal that is fed to sampler 111 controlled by clock 405. It should be noted that according to the presently disclosed subject matter, clock 405 is not necessarily synchronized with the clock of the laser designator, and therefore the laser designator and the seeker can operate independently of each other.

At block 503 the reflected signals received by each of the four quarters (Q1 to Q4) of the sensor head 105 are sampled by a respective sampler 111, operable to sample M samples for each pulse rate interval (PRI), where the M samples can be indexed sequentially. Assuming for example, that the pulse rate of the laser designator is 20 PPS with a respective PRI of 50 milliseconds and sampler 111 is operating at a sampling rate of 100 MHz, sampler 111, samples 5 million samples (M=5 Mega) per each PRI, each sample extending over around 10 nanoseconds. A pulse width of about 10-25 nanoseconds which is generated by the laser designator can be expanded (by pre-amplifier 107 and variable gain amplifier 109) to around 80 nanoseconds, and therefore each true signal (reflected laser pulse) extends over about 80 nanoseconds which correspond to around 8 samples. As mentioned above, in accordance with the presently disclosed subject matter, the clock that controls the operation of sampler 111 is not necessarily synchronized with the clock that controls the pulse generation in the laser designator and therefore it is not known in advance where in the 50 milliseconds of each PRI, the true signal portions (samples of the energy generated by the narrow designating pulse and reflected from the target), will fall (or in other words, where in the 5 million samples of each PRI the relevant 8 samples fall). Thus, in light of a possible low signal to noise ratio, the narrow width of the pulse and uncertainty with regard to the location of the true signal location within a respective PRI, the task of identifying true signal portions within each PRI poses a substantial challenge.

Optionally, in order to reduce the number of samples and increase the intensity of the energy in each sample, consecutive samples can be summed. Accordingly, at block 504, for each M samples of each PRI, horizontal summations of groups of n consecutive samples are performed thereby obtaining I summed values, each value corresponding to a summation of n samples. For example, the 5 million samples mentioned above, can be reduced to 1 million summed values by horizontal summation of each 5 consecutive samples into a summed value. Alternatively, the 5 million samples can be reduced to 1 million summed values by horizontal summation of each 10 consecutive samples, wherein the 5 last samples in one summation, overlap with the 5 first samples of the next summation. Horizontal summation module 407, of each processing channel A to D can be operable to perform horizontal summation of samples received by the respective quarter as described with reference to block 504.

At block 505 each of the I summed values is associated with a respective value based on a predefined criterion. For example, the criterion can be a predefined threshold value. Each of the summed values is compared to the threshold value and in case the intensity of the energy represented by the summed value exceeds the threshold value, the summed value is associated with a value indicating that the summed value represents true signal candidates. True signal candidates potentially represent a true signal-portion (comprising one or more samples) of actual laser energy reflected from the target. Otherwise the summed value is associated with another value indicating that the summed value represents noise. For example, true signal candidates can be assigned with a value of 1 and noise can be assigned with a value of 0.

The threshold value can be calculated according to any method which is known in the art, for example by calculating an average value of all 1 million summed values in a single PRI and multiplying the resulting average by a constant number. The threshold value can be calculated in order to obtain a desired constant false alarm rate (CFAR). According to one example the threshold is calculated in order to obtain around 4000 indications of summed values above threshold, per each PRI. Thresholding module 409 in each processing channel A to D can be operable to perform the operations described with reference to block 505. Thresholding module 409 can be configured to continuously update a dynamic threshold, based on a current number of detections, in order to maintain a desired CFAR.

In some cases, the laser spot reflected from the target falls between two quarters, such that part of the laser spot is located in one quarter and part of the laser spot is located in an adjacent quarter. In such cases, the intensity of the signal in each individual quarter may not exceed the threshold and accordingly no signal is detected, although the laser spot falls on the sensor head.

Optionally, in order to facilitate the detection of reflected laser energy, which falls between two adjacent quarters of seeker head 105, 4 additional intermediate channels can be generated by summing the samples received in each pair of adjacent quarters (block 506). Intermediate channel A-B is generated by summing the respective samples in channel A and channel B; Intermediate channel B-C is generated by summing the respective samples in channel B and channel C; Intermediate channel C-D is generated by summing the respective samples in channel C and channel D; and intermediate channel D-A is generated by summing the respective samples in channel D and channel A. Optionally, another (9^{th} channel) intermediate channel can be generated by summing the values of all four channels. This summing operation of the values in the different adjacent channels implements non-coherent integration, which as is well known in the art, results in the attenuation of the noise with respect to the true signal.

Once generated, each sample (or combination thereof, e.g. I summed values) of the intermediate channels can be associated with a respective value based on a predefined criterion as described earlier with reference to block 505.

A binary matrix (assuming that the summed values are assigned with either 0 or 1) containing I columns and K rows is generated and the values assigned to each summed value of a PRI are inserted in respective cells in a single row in the binary matrix. Thus, according to the example expounded herein, a binary matrix containing 1 million horizontal 1-bit cells is generated for storing the values assigned to each of the 1 million summed values of a single PRI. Each value is inserted to a respective cell i according to the order of appearance in the respective PRI.

According to one example, a logical OR can be performed on each respective (i^{th}) value of all channels (4 channels of 4 respective quarters and the generated intermediate channels) in order to obtain consolidated values from all (e.g. 8) channels. In case the OR operation results in a true value the respective (i^{th}) value is assigned to be 1, otherwise the respective (i^{th}) value is assigned to be 0 (block 507). The operations described above with reference to block 506 and 507 can be performed, for example, with the help of intermediate channels generator 408.

At block 509 it is determined how many rows in the binary matrix have been occupied with values assigned to summed-values of a respective PRI. According to one example, when a given PRI is being processed the PRI is designated with a corresponding PRI index (j) indicating its sequential position.

Accordingly, at block 509 the value of the PRI index j can be compared with the value of K. In case the PRI index is smaller than K (i.e. j<K), the process proceeds to block 513 where the value assigned to each summed value (e.g. 0 or 1 resulting from the OR operation described above) is inserted to a respective cell i in row k, (e.g. k=j) of the binary matrix and continues with the processing of the next PRI (at block 503).

In case PRI index j=K, the process proceeds to block 515 where the value assigned to each summed value (e.g. 0 or 1 resulting from the OR operation described above) is inserted to a respective cell i in row K of the binary matrix. The process proceeds to block 517 where vertical summation of each cell i in K rows is performed, as explained below in detail.

Otherwise, in case PRI index j is greater than K, the earliest row (e.g. row k=0) in the binary matrix is deleted (block 511), all rows in the binary matrix are pushed down by one row, and a new row corresponding to the next PRI is inserted at the top of the binary matrix (e.g. at row k=K−1) (block 515).

The operations described above with reference to blocks 503 to 515 are repeated for each PRI of the received signal. Matrix management module 411 in target detection unit 410 can be configured to perform the operation described herein with reference to blocks 509 to 515.

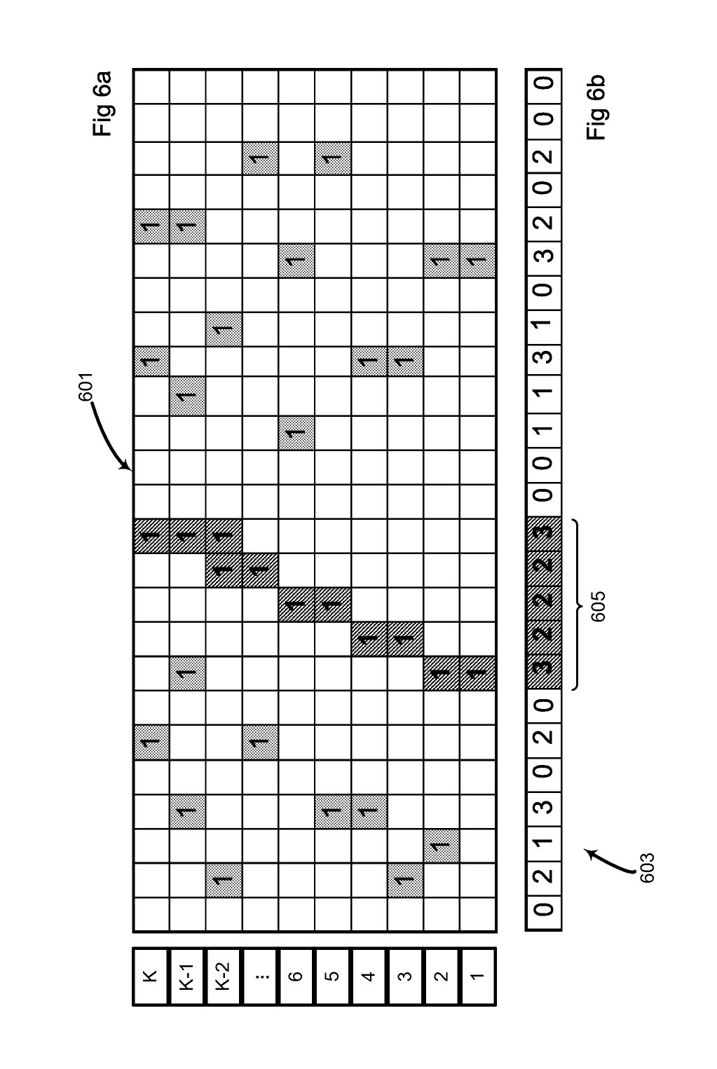

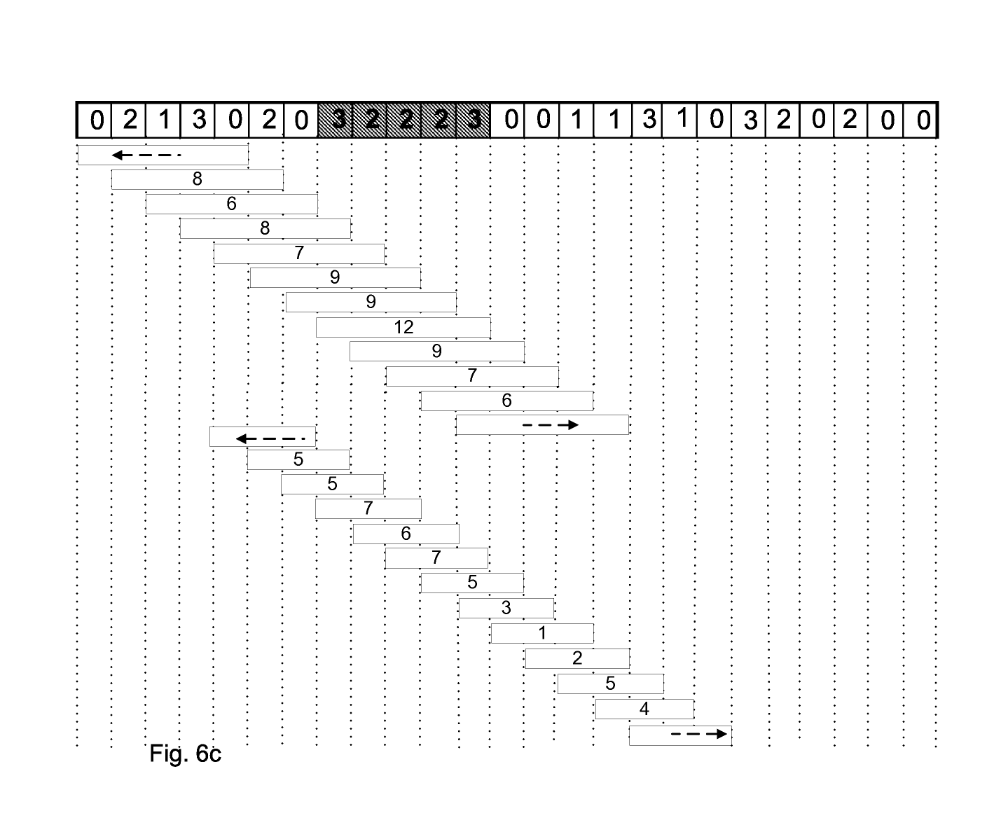

FIG. 6a schematically illustrates an example of a binary matrix in small scale, in accordance with the presently disclosed subject matter. FIG. 6a illustrates a matrix containing 10 rows where the marking in each cell is indicated by means of 1 in case the respective summed value exceeds the threshold, and by means of 0 otherwise. Note that the use of 1 and 0 is merely a non-limiting example and other values can be alternatively assigned in order to denote summed values above and below the threshold. Also, in other examples 1 can be used to denote values below the threshold and 0 to denote values above the threshold.

Note that there are sporadic instances (i.e. false alarms) of cells indicated by 1 across the entire matrix. This stems for example, from random peaks of noise which exceeded the threshold. However, only in one area there is a consistent sequence of cells denoted by 1 vertically extending from top to bottom (the respective cells in FIG. 6a are indicated by diagonal lines in the background).

As explained above, the intensity of the received signal is relatively low (e.g. due to the relatively low pulse power of the laser designator), hindering the detection phase which attempts to discern between true signals and noise. It is therefore required to increase the certainty of detecting a true signal. The consistent appearance of cells with energy intensity above threshold, indicated by 1, within a restricted range of indexes in all rows (or almost all rows) of the binary matrix, can serve as an indication of samples representing a true signal. In order to detect such ranges of indexes, a summation of the values in respective cells in K rows is performed (block 517).

To this end, a summation vector containing I cells is generated and for every cell i (from among I cells), K vertical cells are summed, giving rise to I vertical sums. Each vertical sum is inserted in a respective cell i in a summation vector. Thus, according to the example expounded herein, a summation vector (in the current example a vertical summation vector) containing 1 million cells is generated and the resulting vertical sums are inserted in the respective cells in the vertical summation vector. FIG. 6b schematically illustrates a summation vector, in accordance with the presently disclosed subject matter. Note that each cell i in the summation vector 603 contains a value corresponding to the summation of the respective cells i in K rows of matrix 601.

Each K row represents a single bulk. As mentioned above, once K (e.g. 10) rows are occupied in the binary matrix, the next row is inserted to the binary matrix (corresponding to the next PRI) at the top of the binary matrix (row K in FIG. 6a) and the earliest row in the binary matrix is deleted (row 1 in FIG. 6a), thereby generating a new bulk with K rows.

As is well known in the art, there is a tradeoff between the size of the processed data (which may influence the quality of the obtained result) and the processing time. Accordingly, the value of K may vary depending for example on the available processing speed and the required probability of detection (POD). According to one non-limiting example, K=10, where a vertical summation is performed for every 10 rows, each row corresponding to one PRI. According to this example, the size of each cell in the vertical summation vector is at least 4 bits.

The summation procedure can be performed substantially simultaneously for all I cells within a bulk. FIGS. 6a and 6b demonstrate summation of a bulk. The information generated within the summation vector, in respect of each bulk, can be stored in a data-repository (e.g. computer memory 121).

As mentioned above and illustrated in FIG. 6a cells comprising the value of 1 are clustered within a limited range of horizontal indexes within a binary matrix and are not restricted to a single index. One of the reasons for the spread of the cells is the speed of the intercepting platform. Assuming for example, a PRI of 50 milliseconds and an estimated intercepting platform speed of around 300 meter/sec, a 15 meter drift of the true reflected signal is expected for each PRI. Optionally, in order to compensate, at least partially, for this drift, the indexes of each new row (representing a new PRI) are shifted by one index with respect to the previous row, which is roughly equivalent to 50 nanoseconds (calculated by 15 meters divided by the speed of light).

According to the non-limiting example illustrated in FIG. 4, matrix management module 411 comprises a summation module 413 which is configured to perform the operations described above with reference to block 517.

As may be recalled, according to the example specified herein, it is expected that for each PRI comprising 1 million summed values, around 4000 summed values above threshold (denoted by 1) are detected. The summation of cells enables to narrow down the searching area for true signals by restricting the search to small windows extending over a limited number of cells.

Note that summation vector in FIG. 6b includes a region comprising a cluster of cells (indicated by reference number 605), which is characterized by higher values in comparison to other regions in the summation vector. Such clusters identify ranges of indexes of cells corresponding to summed values above threshold (e.g. indicated by 1), which consistently appear throughout the K rows of a given bulk. Therefore, such clusters (referred herein as “candidate clusters”) potentially represent an area within a PRI that includes true signal portions.

In order to identify candidate clusters within a summation vector each summation vector (corresponding to a certain bulk) undergoes a filtering process (block 519). Filtering can be carried out with the help of filtering module 415 in target detection unit 410.

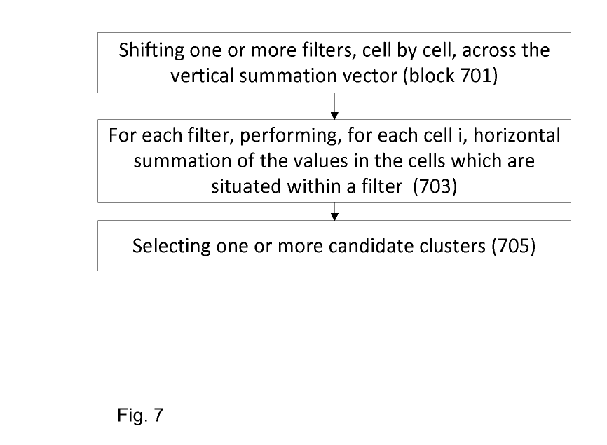

Turning now to FIG. 7, this shows a flowchart illustrating an example of operations carried out during a filtering process, in accordance with the presently disclosed subject matter. One or more filters can be used for identifying candidate clusters in the summation vector where each filter is a sliding window of a predefined size. The number and size of the filters is selected based on the estimated number and size of uncertainties. Uncertainties can include for example, uncertainty in respect of the Doppler frequency shift of the pulse rate, uncertainties due to the velocity of the platform, uncertainties due to the discrepancy between the sampling clock and clock of the laser designator and uncertainty with respect to the speed of the target.

According to one example, the filter is shifted cell by cell, across a vertical summation vector (block 701). Thus, according to this example the filter can be implemented as a FIR filter with coefficient of 1. For each cell i in the summation vector, a summation (according to this example “horizontal summation”) of the values within the cells which reside within the sliding window (i.e. the filter), is calculated. Each value is associated with the respective indexes indicting the position of the filter in the vertical summation vector (block 703). FIG. 6c schematically illustrates the sliding window of two filters along the summation vector. The two filters are represented by rectangles and the values denoted within the rectangles at each position indicate the horizontal summation value at the respective position of the filter.

From the entire number of horizontal summation values calculated for a given vertical summation vector (where this number can be equal, according to one example, to the number of cells in the vertical summation vector less the size of the filter) a predefined number of horizontal summations having a value which matches a predefined criterion are selected (block 705).

For example, assuming that summed values which exceed the threshold are associated with a value which is greater than the value associated with summed values which do not exceed the threshold (e.g. 1 and 0, respectively), horizontal summation values having the highest values are selected as candidate clusters. If, on the other hand, summed values which exceed the threshold are associated with a value which is lower than the value associated with summed values which do not exceed the threshold (e.g. 0 and 1, respectively), horizontal summation values having the lowest values are selected as candidate clusters.

Filtering module 415 can be configured for example, to select from the filters, all horizontal summation values which are greater than 5 and to select the 20 highest values in case more than 20 horizontal summations comply with this criterion.

Reverting now to FIG. 5, optionally in order to reduce the number of candidate clusters, the filtering process can also include a shrinking operation directed for diluting the final batch of candidate clusters (block 521). During the shrinking operation, candidate clusters identified in the same vertical summation vector are compared and in case a plurality of candidate clusters are characterized by ranges of indexes which match a predefined criterion, only one of the candidate clusters is selected and the other candidate clusters are discarded, thereby diluting the number of candidate clusters. For example candidate clusters which are characterized by overlapping indexes can be identified, redundant candidate clusters are discarded, and only a single candidate cluster is retained. For instance, assuming a 10 cells long filter identifies a candidate cluster, which is inclusive of another candidate cluster, which is identified by a 5 cells long filter, during the shrinking operation the shorter candidate cluster can be discarded. Also, during the shrinking operation candidate clusters which are partially overlapping or are located at close indexes can be diluted based on predefined tolerance. The tolerance defines proximity and/or overlapping between the candidate clusters which merits discarding one of the candidate clusters. Filtering module 415 can be configured to perform the shrinking operation as well.

Information with respect to the selected candidate clusters can be stored in a designated data-structure e.g. in a candidate mapping-table (block 523). The stored information includes for example, the indexes of the respective cells of each candidate cluster within the vertical summation vector, the size of the filter, and the respective horizontal summed value. The stored indexes can be for example the indexes at the center of the sliding window or the indexes located at one or both ends of the sliding window.

Assuming for example, that 5 different filters are used, and for each filter the 20 highest horizontal summation values are stored, at the end of the filtering process, 100 candidate clusters are obtained and stored for a given vertical summation vector. As explained above, the number of the candidate clusters can be reduced by the shrinking process.

Mapping of candidate clusters (e.g. in candidate mapping-table) enables to select from the candidate clusters a final candidate cluster representing an area within the raw data, comprising samples corresponding to true signals. To this end, the candidate mapping-table also includes a detection count parameter, which indicates the number of times the same candidate cluster is identified. As mentioned above, a new vertical summation vector is calculated for each new bulk. Each new vertical summation vector is filtered and a new group of candidate clusters are identified. The new candidate clusters are inserted into the candidate mapping-table. In case a first candidate cluster which is identified in a vertical summation vector is determined to be sufficiently similar (e.g. characterized by identical or close indexes) to a second candidate cluster, which already exists in the mapping-table (i.e. a candidate cluster which has been identified with respect to a previous vertical summation vector) the first and second candidate clusters are associated with the same entry in the candidate mapping-table and the detection-count parameter associated with that entry is incremented by one. Similarity between candidate clusters can be determined based on a different criterion, which may be similar, for example, to the criterion applied during the shrinking process described above with reference to block 521. The operations described with reference to block 523 can be performed with the help of mapping-table manager 417.

Since unlike noise which appears at random locations within a PRI, true signals appear consistently within a certain range of samples, it is expected that while those candidate clusters which represent false alarms would appear randomly across the summation vector and would not be tied to specific indexes, candidate clusters which represent true signals would be repeatedly identified in association with the same indexes.

Accordingly, after a predefined number of cycles (where in each cycle a bulk is processed) a final candidate cluster is selected from candidate mapping-table (block 525). In general the candidate cluster with a detection count parameter with the highest value is selected. In case more than one candidate cluster shows identical detection count values, the system can be operable to run for a few additional cycles and then select the final candidate cluster. Selection of the final candidate cluster can be carried out by final candidate selection module 419.

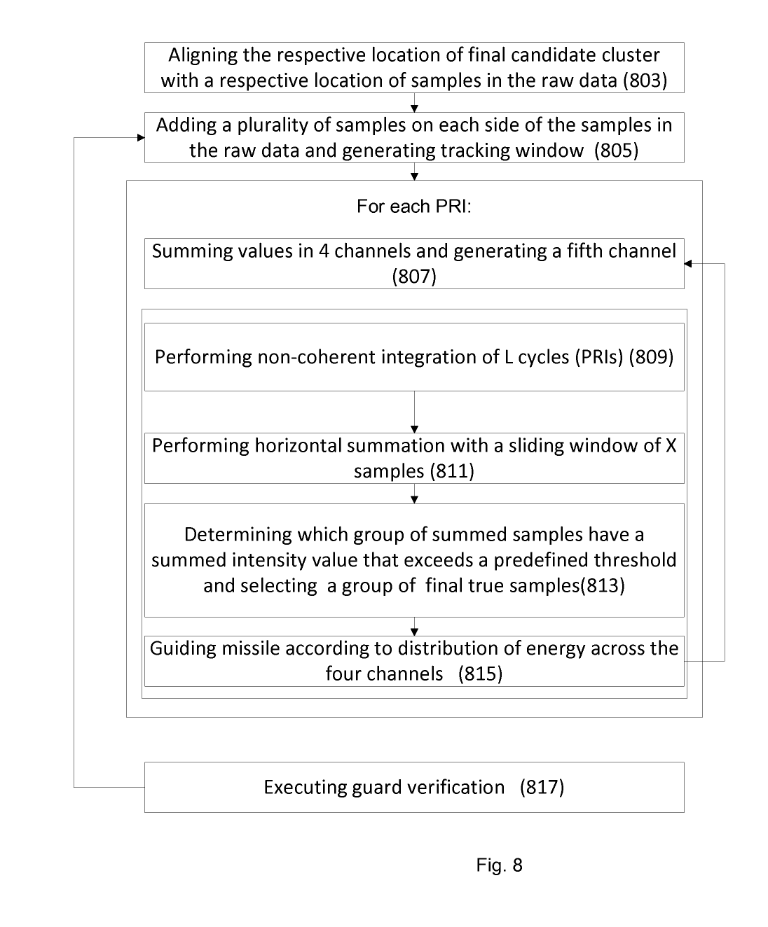

Proceeding now to FIG. 8, which is a flowchart showing operations which are carried out during target tracking process, in accordance with the presently disclosed subject matter. At block 801 the respective location of the final candidate cluster is located within the raw-data. As explained above, sampler 111 is operating at a sampling rate of 100 MHz and samples 5 million samples per each PRI. The 5 million samples represent the raw-data. Recall that each candidate cluster is identified, in the candidate mapping-table, by one or more indexes. Each index corresponds to a cell in the binary matrix, where each cell represents summation of 5 samples, each sample extending over 10 nanoseconds and the entire cell extending over 50 nanoseconds. Thus, in order to locate the position of the final candidate cluster in the raw data, at least one of the indexes within the final candidate cluster is aligned with the respective samples in the raw data of at least 4 channels A, B, C and D. For example, the central index of a final candidate cluster can be aligned with the respective 5 samples in the raw-data. As mentioned above the raw-data can also be indexed, thereby facilitating the alignment of the final candidate cluster to the raw-data.

Once the final candidate cluster is located within the raw-data, a plurality of samples are added on each side of the identified samples in order to create a tracking window for the purpose of tracking the target (block 805). The extension of samples on both sides of the tracking window is made in order to compensate for the uncertainties mentioned above.

According to one non-limiting example, 250 samples are added on each side of each final candidate cluster thereby obtaining a tracking window of 500 samples. The tracking window enables to restrict the tracking of a target to a small region within the entire raw-data where true signal portions are expected to be located. Tracking window generator 421 in target tracking unit can be configured to perform the operations described above with reference to blocks 803 and 805.

Since the data within the tracking window is of considerable smaller size in comparison to the data within a full PRI, it is now possible to store this data and process the stored data. Accordingly, the raw data corresponding to the tracking window of each of the 4 channels is stored in data-repository (e.g. computer memory 121).

In case the energy which is reflected from the target falls in the center of the 4 quarters sensor, the received energy is divided between the 4 quarters and the energy received by each individual quarter may not be sufficient for detection. Therefore, in some cases respective samples in the window of all 4 channels can be summed in order to generate channel E representing the summed energy received in all 4 channels (block 807). According to the example illustrated in FIG. 4, in order to generate a new channel E the data with respect to all 4 tracking windows of each respective channel is transmitted to channel generator 431, which is configured to combine the energy in all 4 tracking windows and create channel E as described above.

The following operations described below with reference to bock 809 to 815 are performed individually on all 5 channels A to E. Optionally non-coherent integration of L cycles (where a new PRI is received in each cycle) is performed with respect to each one of the (500) samples within the window (block 809). The non-coherent integration will strengthen the inherent low signal to noise ratio of each PRI by a factor of \sqrt{L}. For example, non-coherent integration can be performed for every two consecutive cycles improving the signal to noise ratio by \sqrt{2} Non-coherent integration can be performed by true samples identifier module 423 in target tracking module 420.

As mentioned above the laser designator works with a pulse width of about 20-25 nanoseconds which is generated by the laser designator and expanded to around 80 nanoseconds. Accordingly, each pulse (i.e. true signal) spreads over 8 samples of the raw-data (i.e. each sample being around 10 nanoseconds). In order to identify the 8 samples of the true signal within the 500 samples window and obtain a value that represents at least a substantial portion of the energy reflected in a single pulse, horizontal summation of a sliding window of a predefined size (comprising predefined number of samples) can be performed. The sliding window can be shifted sample by sample across the 500 samples window and a summation of X samples is performed for each sample (block 811). The size of the sliding window is determined based on the length of the laser pulse. In the current example, where a pulse is spread across 8 samples, the size of the sliding window can be around 8 samples long (X˜8).

Assuming that for mathematical simplicity a sliding window 10 samples long is used, at block 813 the summed intensity value of each 10 samples is compared to a predefined threshold and the samples corresponding to summed intensity values which exceed the threshold are selected as final true samples to be used for tracking the target. In case more than one summed intensity value exceeds the threshold value, a preferred summed intensity value is selected based on predefined logic. For example, according to a default selection logic, the final true samples located closest to the center of the 500 samples window are selected. According to another example, in case the area between the sensor and the target is filled with obstructive material such as dust, the final true sample which is closest to the far end of the 500 samples window is selected, as other samples with intensity value above the threshold are likely to result from reflection of energy from the obstructive material. The operation described above with reference to block 811 and 813 can be performed by true samples identifier module 423.

At this point a group of final true samples is identified within the raw data for each of channels A to E. The intensity of the sample from all 5 channels is determined and the guiding of the intercepting platform is carried out based on the distribution of energy across the 4 quarters, as known in the art (block 815). Guiding unit 435 is operable to generate guiding instructions for the intercepting platform based on the received intensity of energy in the 5 channels.

The operations described above with reference to blocks 807 to 815 are repeated for every PRI until the intercepting platform reaches its designated target. In each new cycle the tracking window can be shifted along the PRI in order to maintain the position of the final true sample with respect to the tracking window. For example in case the selected final true sample was initially located near the center of the tracking window, the tracking window is shifted so the location of the final true sample is maintained at the same location, near the center of the tracking window.

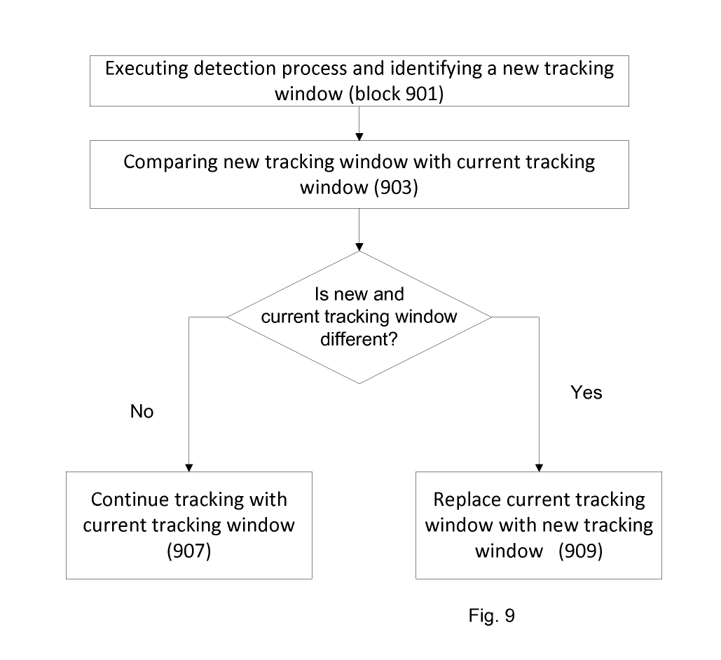

FIG. 9 is a flowchart illustrating the operations performed in a guard process, in accordance with the presently disclosed subject matter. In some cases it may occur that the tracking window is erroneously focused on samples which do not represent a designated target. For example, it may occur that high intensity noise was erroneously detected by target detection module 410 as the true signal. In such a case, tracking module would continuously attempt to track the source of the noise and the intercepting platform would be guided towards that direction.

In order to avoid this type of error, a guard process can be executed (block 817). During the guard process (or target verification process) the target detection process is continuously performed along with the target tracking process. The detection process repeatedly detects a final candidate cluster and every predefined number of cycles the operations described above with reference to blocks 803 and 805 are performed in order to generate a new tracking window based on the detected final candidate cluster (block 901). The location of the new tracking window is compared with the location of the current tracking window, which is being used for tracking the target (block 903). In case a discrepancy, which is greater than a predefined threshold, is found between the locations of the two tracking windows, the current tracking window is replaced by the new tracking window and the tracking process continues based on the new tracking window (block 909). Note that target tracking unit 420 in FIG. 3 comprises a guard module 425, which is configured to run and control a guard process with the help of target detection unit 410 for executing the operations related to identification of the tracking window.

It will also be understood that the system according to the presently disclosed subject matter may be a suitably programmed processing unit. Likewise, the presently disclosed subject matter contemplates a computer program being readable by a computer processor for executing the method of the presently disclosed subject matter. The presently disclosed subject matter further contemplates a machine-readable memory tangibly embodying a program of instructions executable by the machine for executing the method of the presently disclosed subject matter.

It should be further understood that certain embodiments of the presently disclosed subject matter are applicable to the architecture of a laser seeker described with reference to FIGS. 2 and 4. However, the invention is not bound by the specific architecture; equivalent and/or modified functionality may be consolidated or divided in another manner and may be implemented in any appropriate combination of software, firmware and hardware.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1-36. (canceled)

37. A method of detecting a signal reflected from a target designated by a pulse laser spot, the method comprising:
receiving a signal comprising true signal portions reflected from said target, and noise;
sampling a plurality (M) of samples of a plurality of pulse repetition intervals (PRI) in said signal; each sample having a respective intensity value;
assigning, for each sample of said plurality of samples or a combination thereof, at least a first value or a second value based on a comparison of the respective intensity value of each sample or a combination thereof to a given threshold value;
performing summation of respective (i^{th}) indexed assigned values in K PRIs, and obtaining respective summed values; identifying one or more candidate clusters from among said summed values; selecting a final candidate cluster from among said one or more candidate clusters; said final candidate cluster representing a range of indexes that corresponds to true signal portions from among the plurality of samples;
locating said final candidate cluster with respective samples of an incoming PRI, thereby detecting an area within said signal which comprises the true signal portions.

38. The method according to claim 37 further comprising:
prior to performing said summation, inserting said assigned values to a respective cell i in a row of a matrix comprising K rows, each row comprising the assigned values of a respective PRI; and
performing said summation as a summation of a respective cell i in K rows thereby generating a summation vector.

39. The method according to claim 37 wherein said signal is received by a 4 quarters laser sensor, each quarter associated with a respective processing channel, wherein said sampling and assigning is performed by each of said 4 quarters, the method further comprising:
performing a logical OR on each respective (i^{th}) indexed assigned value in each of said 4 processing channels, thereby obtaining a consolidated value from all 4 processing channels and performing said summation with said consolidated value.

40. The method according to claim 37 wherein said signal is received by a 4 quarters laser sensor, each quarter associated with a respective processing channel, wherein said sampling and assigning is performed for each of said 4 quarters, the method further comprising:
summing values of respective samples received in at least each pair of adjacent quarters, thereby generating 4 intermediate processing channels;
performing said assigning on said 4 intermediate processing channels; and
performing a logical OR operation on each respective (i^{th}) indexed assigned value in each of said 4 processing channels and said 4 intermediate processing channels, thereby obtaining a consolidated value from all 8 processing channels.

41. The method according to claim 37 further comprising:
adding a plurality of samples on each side of said area thereby generating a tracking window; and
identifying at least one final true sample within said tracking window, said at least one final true sample representing energy of said laser spot reflected from said target;
wherein said identifying further comprises:
shifting a sliding window of a predefined size along samples in said tracking window;
performing summation of the intensity value of samples in the sliding window in each position of the sliding window;
identifying a position of the sliding window where a respective group of summed samples have a summed intensity value that exceeds a predefined threshold; and
selecting one of the groups of summed samples as final true samples.

42. The method according to claim 37 further comprising:
prior to said assigning, summing groups of n consecutive samples of said M samples, thereby obtaining a combination of samples represented by I summed values.

43. The method according to claim 38 wherein said identifying one or more candidate clusters includes a filtering process comprising:
shifting at least one filter along values in said summation vector, wherein a filter is represented by a sliding window of a predefined size;
for each value in said summation vector:
summing values located within said at least one filter, thereby generating a respective horizontal summation value;
selecting one or more horizontal summation values, having values matching a predefined criterion, as candidate clusters.

44. The method according to claim 37 wherein said signal is received by a 4 quarters laser sensor, each quarter associated with a respective processing channel, said laser sensor being fixed to an intercepting platform, the method further comprising:
summing values in 4 tracking windows of said 4 respective processing channels and generating a fifth channel;
identifying at least one final true sample for each processing channel based on different channels.

45. The method according to claim 37 further comprising;
performing a guard process comprising:
continuously identifying a new tracking window and a new final true sample therein, said final true sample representing energy of said laser spot reflected from said target; and
in case a discrepancy between said new final true sample and said final true sample is identified, replacing said final true sample with said new final true sample.

46. The method according to claim 37 wherein a clock associated with a laser designator, designating said pulse laser spot is not synchronized with a clock associated with a sensor configured for receiving said signal.

47. A laser seeker configured for detecting a signal reflected from a target designated by a pulse laser spot, the seeker comprising:
a sensor associated with at least one processing channel; said processing channel comprising a sampler, an accurate clock and a processing unit;
the sensor is configured to receive a signal comprising true signal portions reflected from said target, and noise;
the sampler and associated accurate clock, are configured to sample a plurality of samples of a plurality of pulse repetition intervals (PRI) of said received signal;
the processing unit is configured to perform at least the following operations:
assign, for each sample of said plurality of samples or a combination thereof, at least a first value or a second value based on a comparison of the respective intensity value of each sample or a combination thereof to a given threshold value; sum respective (i^{th}) indexed assigned values in KPRIs, and obtain respective summed values; identify one or more candidate clusters from among said summed values; select a final candidate cluster from among said one or more candidate clusters; said final candidate cluster representing a range of indexes that corresponds to true signal portions from among the plurality of samples; locate said final candidate cluster with respective samples of an incoming PRI, thereby detecting an area within said signal which comprises the true signal portions.

48. The laser seeker according to claim 47 wherein said processing unit is further configured, prior to performing said summation, to insert said assigned value to a respective cell i in a row of a matrix comprising K rows, each row comprising the assigned values of a respective PRI; and perform said summation as a summation of a respective cell i in K rows thereby generating a summation vector.

49. The laser seeker according to claim 47 wherein said sensor is a 4 quarters laser sensor, each quarter associated with a respective processing channel, each processing channel comprising a sampler configured to sample a signal received by a respective quarter, said assigning is performed for each of said 4 processing channels, said processing unit is further configured to perform a logical OR on each respective (i^{th}) indexed assigned value in each of said 4 processing channels, thereby obtaining a consolidated value from all 4 processing channels and sum said consolidated values.

50. The laser seeker according to claim 47 wherein said sensor is a 4 quarters laser sensor, each quarter associated with a respective processing channel, each processing channel comprising a sampler configured to sample a signal received by a respective quarter, said assigning is performed for each of said 4 processing channels, said processing unit being further configured to:
combine values of respective samples received at each pair of adjacent quarters, thereby generating 4 intermediate processing channels; perform said assigning on said 4 intermediate processing channels; and perform a logical OR operation on each respective (i^{th}) indexed assigned value in each of said 4 processing channels and said 4 intermediate processing channels, thereby obtaining a consolidated value from all 8 processing channels.

51. The laser seeker according to claim 47 wherein said processing unit is further configured to add a plurality of samples on each side of said area thereby generating a tracking window; and identify a final true sample within said tracking window, said final true sample representing energy of said laser spot reflected from said target; and
wherein in order to accomplish said identification said processing unit is further configured to: shift a sliding window of a predefined size along samples in said tracking window; perform summation of the intensity value of samples in the sliding window in each position of the sliding window; identify a position of the sliding window where a respective group of summed samples have a summed intensity value that exceeds a predefined threshold; and select one of the groups of summed samples as final true samples.

52. The laser seeker according to claim 47 wherein said signal is received by a 4 quarters laser sensor each quarter associated with a respective processing channel, said laser sensor being fixed to an intercepting platform, said processing unit being configured to:
identify a final true sample for each processing channel; and find direction to said target based on comparison between the intensity of the final true sample in the different channels.

53. The laser seeker according to claim 47 wherein said processing unit is further configured, prior to said assigning, to sum groups of n consecutive samples of said plurality of samples, thereby obtaining a combination of samples represented by I summed values.

54. The laser seeker according to claim 48 wherein said processing unit is further configured, as part of said identifying one or more candidate clusters to perform a filtering process during which the processing unit is configured to shift at least one filter along values in said summation vector, wherein a filter is represented by a sliding window of a predefined size;
for each value in said summation vector:
to sum values located within said at least one filter, thereby generating a respective horizontal summation value; and to select a predefined number of horizontal summation values, having values matching a predefined criterion, from among all horizontal summation values as candidate clusters.

55. The laser seeker according to claim 51 wherein said processing unit is further configured to sum values in 4 tracking windows of said 4 respective processing channels and generate a fifth channel; and to identify at least one final true sample for each processing channel based on different channels.

56. The laser seeker according to claim 47 wherein said processing unit is further configured to perform a guard process during which the processing unit is configured to continuously identify a new tracking window and a new final true sample therein, said final true sample representing energy of said laser spot reflected from said target; and in case a discrepancy between said new final true sample and said final true sample is identified, to replace said final true sample with said new final true sample.

57. The laser seeker according to claim 47 wherein a clock associated with a laser designator, designating said pulse laser spot is not synchronized with said clock.

58. The laser seeker according to claim 47 integrated in a laser system, the laser system further comprising a laser designator configured for designating said pulsed laser spot.

59. A program storage device readable by a processor, tangibly embodying a program of instructions executable by the processor to perform method of detecting a signal reflected from a target designated by a pulse laser spot, the method comprising:
receiving information indicative of a plurality of samples of each pulse repetition interval (PRI) in a signal reflected from a target designated by a pulse laser spot, the signal comprising true signal portions reflected from said target, and noise;
assigning, for each sample of said plurality of samples or a combination thereof, at least a first value or a second value based on a comparison of the respective intensity value of each sample or combination thereof to a given threshold value;
performing summation of respective (i^{th}) indexed assigned values in K PRIs, and obtaining respective summed values;
identifying one or more candidate clusters for among said summed values;
selecting a final candidate cluster from among said one or more candidate clusters; said final candidate cluster representing a range of indexes within said summation vector that corresponds to true signal portions from among the plurality of samples;
locating said final candidate cluster with respective samples of an incoming PRI, thereby detecting an area within said signal which comprises the true signal portions.
